(19) United States
(12) Patent Application Publication
(10) Pub. No.: US 2015/0324871 A1
(43) Pub. Date: Nov. 12, 2015

(54) CONTEXTUALIZED FAIR RANKING OF CITIZEN SENSOR REPORTS

(71) Applicant: International Business Machines Corporation, Armonk, NY (US)

(72) Inventors: Anton BELOGLAZOV, South Yarra (AU); Carlos Henrique CARDONHA, Sao Paula (BR); Christian GUTTMANN, Melbourne (AU); Fernando KOCH, Florianopolis (BR); Jan RICHTER, Hawthorn (AU); Kent STEER, Melbourne (AU)

(73) Assignee: INTERNATIONAL BUSINESS MACHINES CORPORATION, Armonk, NY (US)

(21) Appl. No.: 14/270,743

(22) Filed: May 6, 2014

(51) Int. Cl. G06Q 30/02

(52) U.S. Cl. CPC G06Q 30/0282

(57) ABSTRACT

Various embodiments perform a fair ranking of citizen sensor reports. In one embodiment, a plurality of citizen sensor reports is received. Each of the plurality of citizen sensor reports is associated with a reporting target. At least one context event is identified for each of the plurality of citizen sensor reports. An impact factor is calculated for each the identified context events with respect to their citizen sensor reports. A rank is assigned to each of the plurality of citizen sensor reports with respect to each remaining citizen sensor report in the plurality of citizen sensor reports. The rank is determined based on at last a set of information within the citizen sensor report and the impact factor calculated for the citizen sensor report.

### BACKGROUND

The present disclosure generally relates to citizen sensor reporting, and more particularly relates to a contextualized fair ranking of citizen sensor reports.

Citizen sensor networks are an emerging paradigm in social computing research. In particular, a citizen sensor network is a network of interconnected participatory citizens who provide observations (or reports) in a specific context. These observations/reports can be used to classify a characteristic(s) or resource(s) of a given domain. However, in many instances, observations/reports can be biased or based on deviant behavior. Therefore, the information provided by these observations/reports can be unreliable.

### BRIEF SUMMARY

In one embodiment, a method for fairly ranking citizen sensor reports is disclosed. The method comprises receiving a plurality of citizen sensor reports. Each of the plurality of citizen sensor reports is associated with a reporting target. At least one context event is identified for each of the plurality of citizen sensor reports. An impact factor is calculated for each of the identified context events with respect to their citizen sensor reports. A rank is assigned to each of the plurality of citizen sensor reports with respect to each remaining citizen sensor report in the plurality of citizen sensor reports. The rank is determined based on at least a set of information within the citizen sensor report and the impact factor calculated for the citizen sensor report.

In another embodiment, an information processing system for fairly ranking citizen sensor reports is disclosed. The information processing system comprises a memory and a processor communicatively coupled to the memory. A ranking manager is communicatively coupled to the memory and the process. The ranking manager is configured to perform a method. The method comprises receiving a plurality of citizen sensor reports. Each of the plurality of citizen sensor reports is associated with a reporting target. At least one context event is identified for each of the plurality of citizen sensor reports. An impact factor is calculated for each of the identified context events with respect to their citizen sensor reports. A rank is assigned to each of the plurality of citizen sensor reports with respect to each remaining citizen sensor report in the plurality of citizen sensor reports. The rank is determined based on at least a set of information within the citizen sensor report and the impact factor calculated for the citizen sensor report.

In a further embodiment, a computer program product for fairly ranking citizen sensor reports is disclosed. The computer program product comprises a storage medium readable by a processing circuit and storing instructions for execution by the processing circuit for performing a method. The method comprises receiving a plurality of citizen sensor reports. Each of the plurality of citizen sensor reports is associated with a reporting target. At least one context event is identified for each of the plurality of citizen sensor reports. An impact factor is calculated for each of the identified context events with respect to their citizen sensor reports. A rank is assigned to each of the plurality of citizen sensor reports with respect to each remaining citizen sensor report in the plurality of citizen sensor reports. The rank is determined based on at least a set of information within the citizen sensor report and the impact factor calculated for the citizen sensor report.

### BRIEF DESCRIPTION OF THE SEVERAL VIEWS OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present disclosure, in which:

FIG. 1 is a block diagram illustrating one example of an operating environment according to one embodiment of the present disclosure;

FIG. 2 is a block diagram illustrating a detailed view of a system architecture implemented within the operating environment of FIG. 1 according to one embodiment of the present disclosure;

FIG. 3 is a block diagram illustrating one example of a reporting interface for generating citizen sensor reports according to one embodiment of the present disclosure;

FIG. 4 is an operational flow diagram illustrating one example of an overall process for performing a fair ranking of citizen sensor reports according to one embodiment of the present disclosure; and

FIG. 5 is a block diagram illustrating one example of an information processing system according to one embodiment of the present disclosure.

### DETAILED DESCRIPTION

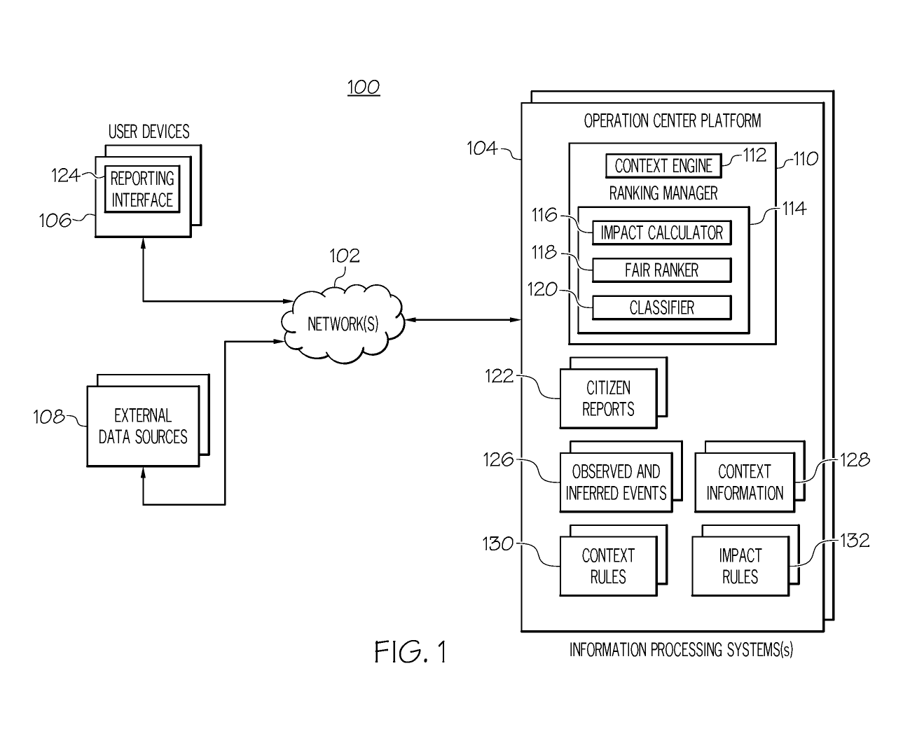

FIG. 1 shows one example of an operating environment 100 for providing context-based fair ranking of citizen sensor reports. The operating environment 100 of FIG. 1 can be a cloud computing environment or a non-cloud computing environment. In a cloud computing environment, various embodiments of the present disclosure discussed below are provided as a service. In one embodiment, the operating environment 100 is a citizen sensor platform, which is a network of interconnected participatory citizens who provide intentional and non-intentional observations (or reports) in a specific context. These observations/reports can be used to classify a characteristic(s) or resource(s) of a given domain. This citizen sensor platform instruments citizens and different domains (e.g., cities, organizations, etc.), interconnects parties, analyzes related events, and provides recommendation and feedback reports.

FIG. 1 shows one or more networks 102 that, in one embodiment, can include wide area networks, local area networks, wireless networks, telecommunication networks, and/or the like. In one embodiment, the environment 100 includes a plurality of information processing systems 104, 106, 108 that are communicatively coupled to the network(s) 102. The information processing systems 104, 106, 108 include one or more servers 104, user systems 106, and various other external data sources 108. The user systems 106 can include, for example, information processing systems such as desktop computers; servers; portable computing devices such as laptop computers mobile/smart phones, tablets, wearable computing devices (e.g., smart watches), personal digital assistants, etc.; and/or the like. The external data sources 108 comprise various types of sensors such as (but not limited to) cameras, traffic sensors, pollution sensors, weather sensors, and/or the like. The external data sources 108 further comprises various agencies such as weather agencies, traffic agencies, security agencies, health agencies, and/or the like.

The information processing system 104, in one embodiment, comprises an operation center platform 110. The operation platform includes a context engine 112 and a ranking manager 114. The ranking manager 114 comprises an impact calculator 116, a fair ranker 118, and a classifier 120. Each of these components of the operation center platform 110 is discussed in greater detail below. The operation center platform 110 and/or one or more of its components may be distributed across a plurality of information processing systems.

As will be discussed in greater detail below, the operation center platform 110 collects information from citizen sensor reports 122 generated by user devices 106. In this embodiment, users act as sensors to detect events/situations (herein referred to as “incidents”) in a given environment and report and/or provide feedback on these events and situations. Users generate citizen sensor events/reports 122 using a reporting interface 124 disposed on the user devices 104. A reporting interface 124 comprises, for example, one or more applications and/or application programming interfaces that allow a user to report incidents on the spot. In particular a reporting interface 124 allows a user to enter information regarding a given incident that is presently occurring or that has occurred in the past. For example, using the reporting interface 124 a user is able to provide/report the quality of service received from an employee of an establishment; any observed or perceived security threats; current traffic/road conditions; observed pollution; public illumination problems; and/or the like.

The information entered into the reporting interface 124 by the user is referred to herein as a citizen sensor event (CSE) that mark events/situations observed or experienced by the user. The reporting interface 124 sends these CSEs to the operation center platform 110 as citizen sensor reports (CSRs) 122. In another embodiment, a CSR 122 further comprises automated sensed information associated with the reported incident. Automated sensed information comprises data such as (but not limited to) situational data and local context data. Situational data comprises information such as (but not limited to) time, user device location, orientation, and/or the like. Local context data comprises information related to the environment surrounding the location where the reported incident took place. For example, local context data can comprise related events; surrounding parties; surrounding objects; still images, video, and audio of the surrounding environment; weather information; and/or the like.

The operation center platform 110 stores, indexes, and groups the information provided by the citizen sensor reports 122. The operation center platform 110 processes this information by applying one or more analytical models to the information, generating various reports, and/or the like. For example, the operation center platform 110 applies one or more analytical models to the reports 122 to identify events observed by users and/or external data sources, and to also infer events that have occurred. The operation center platform 110 stores these events as observed and inferred events 126. The operation center platform 110 utilizes one or more context rules 128 to determine the context associated with the observed and inferred events 126, and store a set of context information 128 associated with the determined/identified context. One or more impact rules 132 are utilized by the operation center platform 110 to determine/calculate the impact of the identified context on the citizen sensor reports 122. The operation center platform 110 utilizes the calculated impact to perform a fair ranking of the citizen sensor reports.

The operation center platform 110 can be implemented within various and diverse domains such as (but not limited to) health institutions, transportation, banking, public services, commerce, and/or the like. For example, an organization can provide a citizen sensor application (reporting interface) for positive agenda where end-users provide compliments to staff members by taking a picture and recording the name of a staff member that provided a satisfactory quality of service. The application sends these reports to the operation center platform 110, which stores, indexes, and analyzes the information in the citizen sensor reports. The operation center platform 110 ranks “the best employee” in one institution and/or all institutions in a region taking into account parameters of (local and global) context that might have influenced the report creator during the reporting process. For example, the operation center platform 110 can calculate the “fair rank” for these reports, taking into consideration (local and global) context information, such as, if the reports have been influence (positively or negatively) by surrounding events (e.g., long waiting lines, short consulting times, availability of resources, etc.) This calculation yields a distribution that takes into consideration external factors to adjust regulation parameters (weights) in order to provide fair ranking to the classification provided by the citizen reports.

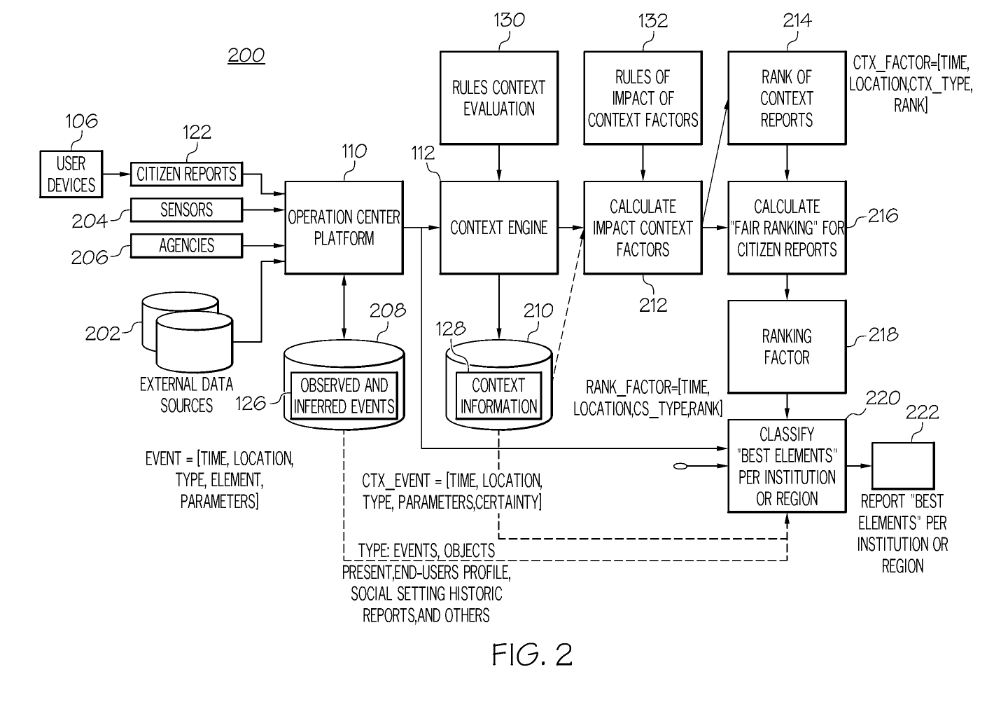

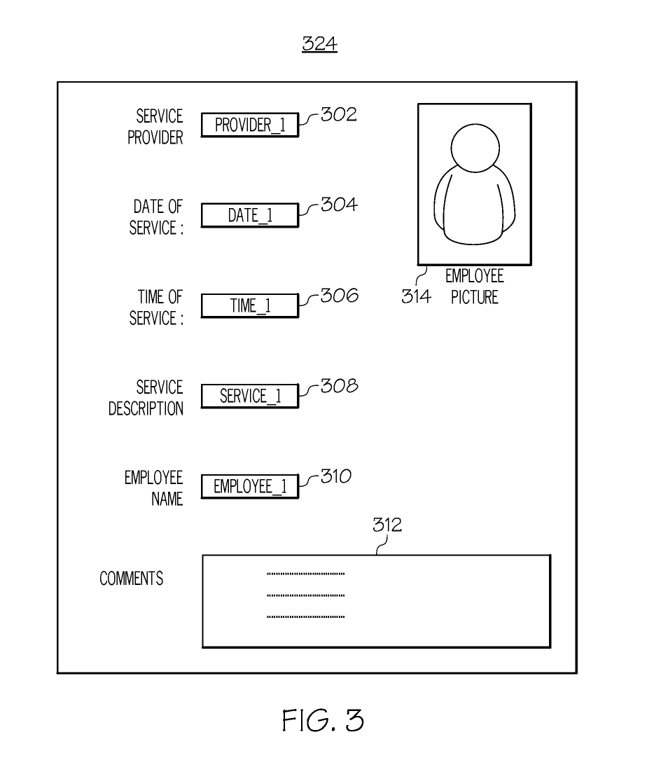

FIG. 2 shows a detailed view of a system architecture 200 implemented within the operating environment 100 of FIG. 1 for performing a contextualized fair ranking of citizen sensor reports. As discussed above, the operation center platform 110 obtains a set of information from external data sources 202 such as user devices 106, sensors 204, and agencies 206. Users report or provide feedback (i.e., intentional sensing) on a given incident that is presently occurring or that has occurred in the past utilizing a reporting interface 124. FIG. 3 shows one example of a reporting interface 326. In this example, the reporting interface 326 allows the user to provide quality of service feedback for hospital care. However, it should be noted that reporting interfaces for other domains are applicable as well.

In particular, the reporting interface 324 of FIG. 3 comprises a first field 302 for entering the name or identifier of the service provided (e.g., hospital name); a second and third field 304, 306 for entering data and time information, respectively, associated with the service received by the user; a fourth field 308 for entering a description of the service(s) received by the user; a fifth field 310 for entering the name(s) of the employee(s) that assisted the user; and a sixth field 312 for entering comments regarding the employee(s) and/or service(s). The reporting interface 324 also comprises an area 314 for storing/displaying a picture of the employee(s) who assisted the user. The user is able to capture a picture of the employee(s) utilizing his/her user device 106.

It should be noted that a reporting interface 124 can also present information associated with automated sensed incidents to the user such as (but not limited to) traffic conditions, queue/line waiting times, security conditions at a given location; pollution conditions at a given location; illumination conditions at a given location, and/or the like. In this embodiment, the user is able to provide his/her feedback (annotations) regarding the automated sensed information. For example, the reporting interface 124 receives a set of automated sensed information when the user is within at least a given threshold distance from the location associated with the incident. The reporting interface 124 presents this automated sensed information to the user. The user then annotates the information by confirming the automated sensed information, adding a description of the automated sensed information, and/or the like.

Once the user has completed entering information such as CSEs into the reporting interface 124, the user device 106 sends the information entered into the interface 124 to the operation center platform 110 as a CSR 122. It should be noted that in addition to the information/annotations entered into the interface 124, the reporting interface 124 can augment this information with non-intentional (automated sensed) information such as contextual information (e.g., location, user profile, sensor data, and/or the like). For example, the reporting interface 124 can automatically obtain location information (e.g., global positioning satellite information); weather information; pollution information; health information; security threat information; traffic information; and/or the like. In the current example, the reporting interface 124 obtains address information for the service provider entered into the reporting interface 124 by the user; weather information for an area surrounding the service provider; health information related to disease outbreaks in an area surrounding the service provider; and/or the like. This additional information is also sent to the operation center platform 110 as part of or in addition to the CSR 122.

It should be noted that the non-intentional (automated sensed information) can also be provided to the operation center platform 110 by various sensors within or surrounding the location where the incident occurred and/or by one or more agencies. For example, the operation center platform 110 can obtain the weather information for the date(s) and time(s) associated with the CSR 122 from a weather sensor and/or weather agency. The operation center platform 110 can also obtain the health information from a health agency such as the Center for Disease Control and Prevention.

The operation center platform 110 receives the CSRs 122 from user devices 106. One or more data interface modules of the platform 110 generate a set of observed (and inferred) events 126 from the received CSRs 122 for a given location and/or domain. In one embodiment, an inferred event is an event that has not been directly observed, but can be deduced with some acceptable level of confidence from available evidence. For example, a photo of two damaged vehicles with irregular orientation in the middle of an intersection is not direct evidence that there was a collision, but a collision event can reasonably be inferred. The forms of inference vary depending on the available evidence. In one embodiment, the data interface modules utilize one or more inference engines to infer events based on human-defined ruled and/or rules learned from training examples. These events 126 are identified directly from and/or are inferred from the citizen reports and related information 124. The observed/inferred events 126 are then stored within one or more data repositories 208 as data structures (tuples) t′. The data structures comprise, for example, {userID, incidentID, incidentType, time, location, element, parameters}, where userID identifies the user who created the CSR 122, incidentID is the identifier (ID) of the reported incident, incidentType is the type of incident (positive service received from an employee; negative service received from an employee; car accident; traffic jam; security threat; etc.), time indicates when the incident occurred, location indicates the geo-location coordinates of the place where the incident took place, element describes the target of the report (e.g. staff, service, institution, etc.), and parameters detail the incident.

The operation center platform 110 utilizes one or more data processing modules to process the set of observed/inferred events 126 by pre-processing, storing, and classifying the information; storing the raw and processed information into one or more data repositories 208; and storing t′ as part of the set of tuples T. The pre-processing operations depend on the type of analysis that is to be conducted. For example, potentially incorrect reports can be removed from the database by filtering out those that are clearly redundant (e.g., two reports submitted by the same user in a very short period of time containing exactly the same information) and those comprising clearly wrong measurements (e.g., reports associated with geographical coordinates located in the middle of the ocean). Storing modules depend on the particular embodiment. Classification criteria depend on the particular embodiment as well. By way of a non-limiting example, reports can be classified according to the frequency with which similar ones have been made, and this is a task that can be accomplished with a cross-relation of reports of same type associated to a certain restricted area during a certain period of time. Other embodiments may consider weighted reports, where these weights stem, e.g., from users' reputations.

The context engine 112 of the operation center platform 110 processes the observed and inferred events 126 based on one or more context rules 130. The context engine 112 utilizes these rules 130 to infer a set of context events (information) 128 associated with a CSR 122, and stores these context events 128 in a context repository 210. In one embodiment, context rules 130 determine which events 126 could impact the veracity of information being submitted in CSRs. For example, there can be a rule that states “if person x has been waiting for more than 60 minutes (the event) and then submits a report on the performance of a staff member y, and the job role of staff member y has no connection to the waiting time of person x, then record the event as a context event having an impact on the report”.

In one embodiment, context events 128 are attributes of the surrounding environment where citizen sensor reports 122 are being generated. Examples of context events include (but are not limited to) time, location, events, objects present, end-users' profiles, social setting, historic reports, and/or the like. These attributes can influence how the end-user interacts with the reporting interface 124. In the above example directed to a health institution, the context events 128 can encompass average waiting time for consultations, diseases being consulted, time per consultation, profile of medical staff, profile of nursing and support staff, other resources available at the institution, information about existing disease outbreaks, historical information about health center performance, and/or the like.

In another embodiment, the context engine 112 extracts context events from the CSR report 122 itself. For example, when generating the CSR report 122 the reporting interface 124 obtains context information associated with the surrounding environment where citizen sensor reports 122 are being generated. In this embodiment, the reporting interface 124 obtains context information from the user device 106, one or more external sensors, and/or one or more agencies. The CSR report 122 attaches this context information to the CSR report 122 as context events. The context engine 112 extracts these context events from the CSR report 122 and stores the context events in the context repository 214.

Context events 128 are stored within the repository 210 as a tuple in the form of {time, location, type, certainty, parameters}. Time comprises date/time information of the context event; location represents the geo-location coordinates of the context event; type describes the type of the context event (e.g., object present, profile classification, social setting, historical reports, etc.); certainty describes the estimated certitude that this evaluation is correct; and parameters detail the context event. In one embodiment, certainty can be associated with the context rules and assigned to context events depending on which rule has been applied. This is to account for the inaccuracy in such rules. For example, how people react to having to wait for some service differs, and there can be uncertainty in how this inconvenience translates to the feedback a person gives is difficult. Therefore, the uncertainty of such a rule would be higher. The actual values can be specified when defining the rule. The certainty or uncertainty can be computed through statistical analysis of historical information or based on the expert judgment of behavioral psychologists.

In many instances the context associated with an incident can have an influence on the information entered into a CSR 122 by the user. For example, consider Public Health centers that provide the reporting interface 124 to users. As in the example above, users provide compliments to health care staff on individual bases through the reporting interface 124. In this example, there is Health_Center_A in a region R1 whose workload is affected by an outbreak of some specific disease in that region. Moreover, the profile of the medical staff is not the best distribution for the demands of treating this disease. There is also a shortage of operational resources (e.g. instruments, medicine, etc.). Consequently, the queuing times in this institution is very high and the time per consultation is short, both due to the lack of ability from medical staff and as a measure to cope with the excessive load.

In this example, there is also Health_Center_B in another region R2 that is not affected by the outbreak. This institution has similar medical and operational resources as Health_Center_A. The workload is operating as predicted and under the threshold of resource capacities. The queuing times are very low, and the time per consultation is normal. The users enter Health_Center_A and Health_Center_B; wait in the queue; have their consultations; and enter citizen sensor reports indicating “good service” (or “bad service”) being provided by medical staff and support personnel. In this example, the staff at Health_Center_A is less likely to receive “positive reports” due to the context events (e.g., the negative conditions discussed above) associated with the environment.

Therefore, the operation center platform 110 takes into consideration the characteristics of the local context (e.g., social influence from peers in the same location, influence of the surrounding environment, etc.) and, optionally, the global context (e.g., historical information, other reports for the same incident, etc.) in order to fairly rank CSRs 122. In this embodiment, the ranking manager 114 of the operation center platform 110 calculates the impact that context events have on CSRs 122. The impact calculator 116 of the ranking manager 114 applies one or more impact rules 132 to the context events 128, and calculates the impact 212 of context events based on types of CSRs 122. The impact calculator 116 utilizes these calculated impact factors/weights 214 to generate a rank 216 of context factors per domain (the incident type or entity for which CSRs 122 are generated).

In particular, given a CSR rᵢ the impact calculator 116 determines if the CSR rᵢ comprises negative, neutral, or positive feedback regarding the incident for which the report was generated. The impact calculator 116 then assigns a value v to the CSR rᵢ based on the identified negative, neutral, or positive feedback. For example if a report comprises negative feedback v(rᵢ)=−1; if a report comprises neutral feedback v(rᵢ)=0; and if a report comprises positive feedback v(rᵢ)=1. The impact calculator 116 then performs an absolute evaluation of each context event e to which a set r(e) of reports is associated, as given by:

$$v ( e ) = {\sum }_{{r}_{i} ∈ r ( e )} v ( {r}_{i} ) . \qquad ( EQ 1 )$$

The impact calculator 116 normalizes the values v of context events e to the [0,1] interval by applying a logistic function to the value v(e), which is given by:

$$l ( e ) = \frac{1}{1 + {e}^{- v ( e )}} , \qquad ( EQ 2 )$$

where l(e) is the normalized impact factor of a given context event e.

In one embodiment, the impact factor of a context event is calculated based on assigning values to reports according to their content. For example, if a report is associated to the quality of service provided in a hospital, the report is assigned to some positive value (e.g., +1) if the user is saying that she liked the service; a negative value (e.g., −1) if the user disliked the service; and 0 if the opinion was neutral. Based on these values, the impact calculator 116 evaluates the impact factor of context events according to EQ 1. One example rule is: “Parking fines make people unhappy, which may bias their opinion of unrelated services. This bias decreases with the time between receiving the fine and submitting the report (CSR)”. The rule can be expressed as an equation: context_factor(parking_fine)=1/dt, where dt is the time between receiving the fine and submitting the report.

Once the impact calculator 116 has calculated the impact factors v(e) (or the normalized impact factor l(e)) 212 for each context event e associated with a given incident/domain type, the impact calculator 116 generates a set of ranked/weighted context events/factors 214. Each ranked context event comprises at least {time, location, ctx_type, rank}. Time comprises date/time information of the context event; location represents the geo-location coordinates of the context event; ctx_type describes the type of the context event (e.g., object present, profile classification, social setting, historical reports, etc.); rank comprises the impact value of the given context event. In one embodiment, a context event with a higher rank has a greater impact on the information entered into a CSR report 122 than a context event with a lower rank.

The fair ranker 118 of the ranking manager 114 utilizes the set of ranked context events 214 to calculate a fair ranking 216 of the CSR reports 122 for a given domain. The fair ranking performed by the ranking manager 114 ensures that given the impact factor l(e) of a context event e, a negative (positive) report has less impact if l(e)<0(l(e)>0) and that a positive (negative) report has more of an impact if l(e)>0(l(e)<0). Consider the example given above directed to a health care institution. In this example, the staff at Health_Center_A is less likely to receive “positive reports” due to the context events (e.g., the negative conditions discussed above) associated with the environment even though at least some of the staff provided the same quality of service as the staff at Health_Center_B. Therefore, the impact of the context events associated with Health_Center_A at the time CSRs 122 were generated are taken into consideration to ensure that the staff of Health_Center_A are fairly/equally evaluated with respect to the staff of Health_Center_B.

In this embodiment, given a CSR rᵢ associated with a context event e(rᵢ), the fair ranker 118 calculates a contextualized weighted value w(rᵢ) 216 of the CSR rᵢ based on the rank 214 associated with its context events e as follows:

if v(r)v(e)≧0,

$$w ( {r}_{i} ) = \frac{v ( {r}_{i} )}{1 + {e}^{- v ( e )}} , \qquad ( EQ 3 )$$

and

if v(r)v(e)<0,

$$w ( {r}_{i} ) = \frac{v ( {r}_{i} ) ( 1 + {e}^{- v ( e )} ) - 1}{1 + {e}^{- v ( e )}} . \qquad ( EQ 4 )$$

If an a report is associated with multiple context events, let e₁, e₂, . . . , eₙ be the set of events to which report r is associated, and let x₁, x, . . . , xₙ be numbers in [0,1] such that x₁+x₂+ . . . +xₙ=1. Let v(e) be denoted as v(e)=x₁v(e₁)+x₂v(e₂)+ . . . +xₙv(eₙ). Equations EQ 3 and EQ 4 can be applied directly in order to evaluate the impact of multiple context events in report r. The values x₁, x₂, . . . , xₙ are effectively weights on the relative influence of context events, and can be set by a subject matter expert.

The fair ranker 118 creates a ranking factor 218 for reach CSR 122 in the form of {time, location, cs_type, rank}, where time is the date/time that the incident associated with the CSR occurred; location indicates the geo-location coordinates of the place where the incident associated with the CSR took place; cs_type is the type of incident (positive service received from an employee, negative service received from an employee, car accident; traffic jam, security threat, etc.); and rank comprises the contextualized weighted value w(rᵢ) of the CSR.

The fair ranker 118 utilizes the rank factors 218 calculated for the CSRs 122 to determine a fair rank/value for a given element m (e.g., the target of the report (e.g. staff, service, institution, etc.) of a domain. The fair ranker 118 identifies CSRs 122 associated with a given element based on at least the time, location, type, and/or element information associated with the CSRs 122. The fair ranker 118 then determines the fair rank f(m) 218 for each identified CSRs 122 as follows:

$$f ( m ) = {\sum }_{{r}_{i} ∈ R ( m )} w ( {r}_{i} ) . \qquad ( EQ 5 )$$

For example, if the target (element) of CSRs 122 is quality of service provided by staff of a health institution, the fair ranker 118 takes the sum of all the contextualized weights 218 for each CSR rᵢ in the set of CSRs R(m) associated with a given staff member. The result of this summation is the fair rank/value for the given staff member.

The classifier 120 of the ranking manager 114 then performs a classification 220 of the elements of interest based on the calculated fair ranks. For example, the classifier orders the elements according to their fair ranks and identifies the best elements, the worst elements, and/or the like. In the current example, the classifier utilizes the fair ranks to identify the best staff members in terms of service in a region comprising Health_Center_A and Health_Center_B. The operations center 110 then generates one or more reports 222 comprising the results of the classification performed by the classifier 120.

Accordingly, one or more embodiments determine the fair rank of citizen sensor reports by taking into consideration local and global context information, such as, if the reports have been influenced (positively or negatively) by surrounding events, e.g., long waiting lines, short consulting times, availability of resources, etc. This allows for improved classification, prioritization, and filtering of citizen sensor reports. Also citizen sensor reports can be fairly analyzed in contextualized scenarios and specific domains. In addition, the calculated fair rank leads to a distribution that takes in consideration external factors to adjust regulation parameters (weights) in order to provide fair ranking to the classification provided by the citizen sensor reports.

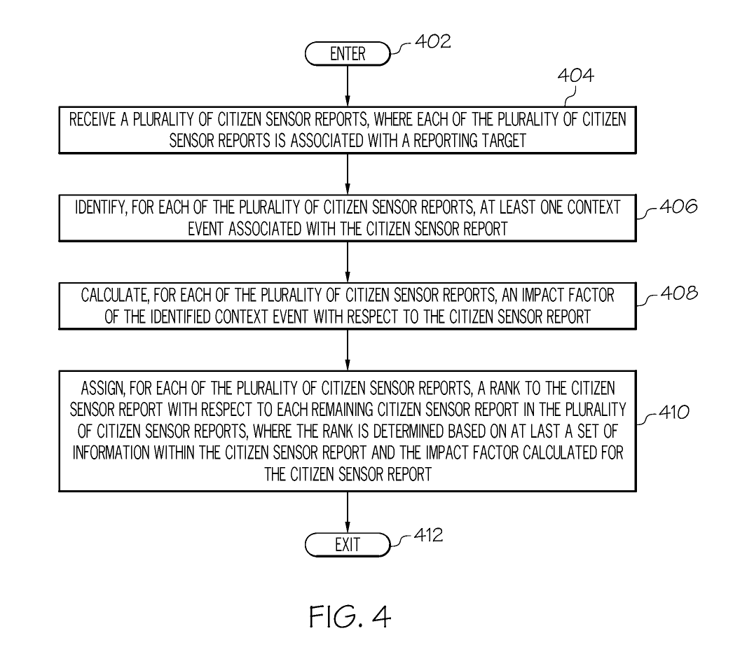

FIG. 4 is an operational flow diagram illustrating one example of an overall process for performing a fair ranking of citizen sensor reports. The operational flow diagram of FIG. 4 begins at step 402 and flows directly to step 404. The ranking manager 114, at step 404, receives a plurality of citizen sensor reports 122. Each of the plurality of citizen sensor reports 122 is associated with a reporting target. The ranking manager 114, at step 406, identifies at least one context event 128 for each of the plurality of citizen sensor reports 122. The ranking manager 114, at step 408, calculates an impact factor for each the identified context events 128 with respect to their citizen sensor reports 122. The ranking manager 114, at 410, assigns a rank to each of the plurality of citizen sensor reports 122 with respect to each remaining citizen sensor report in the plurality of citizen sensor reports 122. The rank is determined based on at least a set of information within the citizen sensor report and the impact factor calculated for the citizen sensor report. The control flow exits at step 412.

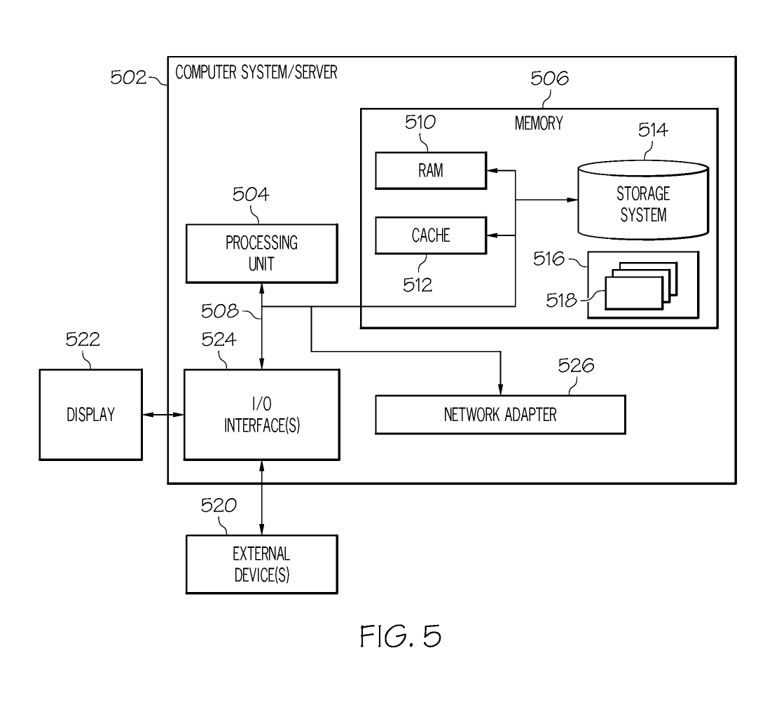

FIG. 5 shows a block diagram illustrating an information processing system that can be utilized in various embodiments of the present disclosure such as the information processing system 102 shown in FIG. 1. The information processing system 502 is based upon a suitably configured processing system configured to implement one or more embodiments of the present disclosure. Any suitably configured processing system can be used as the information processing system 502 in embodiments of the present disclosure. The components of the information processing system 502 can include, but are not limited to, one or more processors or processing units 504, a system memory 506, and a bus 508 that couples various system components including the system memory 506 to the processor 504.

The bus 508 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Although not shown in FIG. 5, the main memory 506 includes at least the ranking manager 114 and its components shown in FIG. 1. Each of these components can reside within the processor 504, or be a separate hardware component. The system memory 506 can also include computer system readable media in the form of volatile memory, such as random access memory (RAM) 510 and/or cache memory 512. The information processing system 502 can further include other removable/non-removable, volatile/non-volatile computer system storage media. By way of example only, a storage system 514 can be provided for reading from and writing to a non-removable or removable, non-volatile media such as one or more solid state disks and/or magnetic media (typically called a “hard drive”). A magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus 508 by one or more data media interfaces. The memory 506 can include at least one program product having a set of program modules that are configured to carry out the functions of an embodiment of the present disclosure.

Program/utility 516, having a set of program modules 518, may be stored in memory 506 by way of example, and not limitation, as well as an operating system, one or more application programs, other program modules, and program data. Each of the operating system, one or more application programs, other program modules, and program data or some combination thereof, may include an implementation of a networking environment. Program modules 518 generally carry out the functions and/or methodologies of embodiments of the present disclosure.

The information processing system 502 can also communicate with one or more external devices 520 such as a keyboard, a pointing device, a display 522, etc.; one or more devices that enable a user to interact with the information processing system 502; and/or any devices (e.g., network card, modem, etc.) that enable computer system/server 502 to communicate with one or more other computing devices. Such communication can occur via I/O interfaces 524. Still yet, the information processing system 502 can communicate with one or more networks such as a local area network (LAN), a general wide area network (WAN), and/or a public network (e.g., the Internet) via network adapter 526. As depicted, the network adapter 526 communicates with the other components of information processing system 502 via the bus 508. Other hardware and/or software components can also be used in conjunction with the information processing system 502. Examples include, but are not limited to: microcode, device drivers, redundant processing units, external disk drive arrays, RAID systems, tape drives, and data archival storage systems.

As will be appreciated by one skilled in the art, aspects of the present disclosure may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit”,” “module”, or “system.”

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for fairly ranking citizen sensor reports, the method comprising:
receiving a plurality of citizen sensor reports, wherein each of the plurality of citizen sensor reports is associated with a reporting target;
identifying, for each of the plurality of citizen sensor reports, at least one context event associated with the citizen sensor report;
calculating, for each of the plurality of citizen sensor reports, an impact factor of the identified context event with respect to the citizen sensor report; and
assigning, for each of the plurality of citizen sensor reports, a rank to the citizen sensor report with respect to each remaining citizen sensor report in the plurality of citizen sensor reports, wherein the rank is determined based on at least a set of information within the citizen sensor report and the impact factor calculated for the citizen sensor report.

2. The method of claim 1, wherein the identifying comprises:
analyzing a set of automated sensed information comprising at least time data and location data associated with the citizen sensor report; and
determining, based on the analyzing, a current state of an environment associated with the reporting target.

3. The method of claim 1, wherein the calculating comprises:
identifying, from the plurality of citizen sensor reports, a set of citizen sensor reports associated with a given content event; and
determining, for each of the set of citizen sensor reports, that the citizen sensor report comprises one of positive feedback, neutral feedback, and negative feedback associated with the reporting target.

4. The method of claim 3, wherein the calculating further comprises:
assigning, for each of the set of citizen sensor reports, a value to the citizen sensor report based on the one of positive feedback, neutral feedback, and negative feedback associated with the reporting target; and
calculating the impact factor of the context event as a sum of all the values assigned to the set of citizen sensor reports.

5. The method of claim 4, wherein the assigning comprises:
calculating a contextualized weight value for the citizen sensor report based on the impact factor, wherein a lower contextualized weight value is calculated based on the impact factor being above a given threshold, and wherein a higher contextualized weight value is calculated based on the impact factor being below the given threshold.

6. The method of claim 1, wherein the context event comprises at least one of time information, location information, weather information, health information, and queue waiting times.

7. The method of claim 1, further comprising:
classifying the reporting target of each of the plurality of citizen sensor reports based on the rank assigned to each of the citizen sensor reports.

8. An information processing system for fairly ranking citizen sensor reports, the information processing system comprising:
a memory;
a processor communicatively coupled to the memory; and
a ranking manager communicatively coupled to the memory and the processor, wherein the ranking manager is configured to perform a method comprising:
receiving a plurality of citizen sensor reports, wherein each of the plurality of citizen sensor reports is associated with a reporting target;
identifying, for each of the plurality of citizen sensor reports, at least one context event associated with the citizen sensor report;
calculating, for each of the plurality of citizen sensor reports, an impact factor of the identified context event with respect to the citizen sensor report; and
assigning, for each of the plurality of citizen sensor reports, a rank to the citizen sensor report with respect to each remaining citizen sensor report in the plurality of citizen sensor reports, wherein the rank is determined based on at least a set of information within the citizen sensor report and the impact factor calculated for the citizen sensor report.

9. The information processing system of claim 8, wherein the identifying comprises:
analyzing a set of automated sensed information comprising at least time data and location data associated with the citizen sensor report; and
determining, based on the analyzing, a current state of an environment associated with the reporting target.

10. The information processing system of claim 8, wherein the calculating comprises:
identifying, from the plurality of citizen sensor reports, a set of citizen sensor reports associated with a given content event; and
determining, for each of the set of citizen sensor reports, that the citizen sensor report comprises one of positive feedback, neutral feedback, and negative feedback associated with the reporting target.

11. The information processing system of claim 10, wherein the calculating further comprises:
assigning, for each of the set of citizen sensor reports, a value to the citizen sensor report based on the one of positive feedback, neutral feedback, and negative feedback associated with the reporting target; and
calculating the impact factor of the context event as a sum of all the values assigned to the set of citizen sensor reports.

12. The information processing system of claim 11, wherein the assigning comprises:
calculating a contextualized weight value for the citizen sensor report based on the impact factor, wherein a lower contextualized weight value is calculated based on the impact factor being above a given threshold, and wherein a higher contextualized weight value is calculated based on the impact factor being below the given threshold.

13. The information processing system of claim 8, wherein the method further comprises:
classifying the reporting target of each of the plurality of citizen sensor reports based on the rank assigned to each of the citizen sensor reports.

14. A computer program product for fairly ranking citizen sensor reports, the computer program product comprising:
a storage medium readable by a processing circuit and storing instructions for execution by the processing circuit for performing a method comprising:
receiving a plurality of citizen sensor reports, wherein each of the plurality of citizen sensor reports is associated with a reporting target;
identifying, for each of the plurality of citizen sensor reports, at least one context event associated with the citizen sensor report;
calculating, for each of the plurality of citizen sensor reports, an impact factor of the identified context event with respect to the citizen sensor report; and
assigning, for each of the plurality of citizen sensor reports, a rank to the citizen sensor report with respect to each remaining citizen sensor report in the plurality of citizen sensor reports, wherein the rank is determined based on at least a set of information within the citizen sensor report and the impact factor calculated for the citizen sensor report.

15. The computer program product of claim 14, wherein the identifying comprises:
analyzing a set of automated sensed information comprising at least time data and location data associated with the citizen sensor report; and
determining, based on the analyzing, a current state of an environment associated with the reporting target.

16. The computer program product of claim 15, wherein the calculating comprises:
identifying, from the plurality of citizen sensor reports, a set of citizen sensor reports associated with a given content event; and
determining, for each of the set of citizen sensor reports, that the citizen sensor report comprises one of positive feedback, neutral feedback, and negative feedback associated with the reporting target.

17. The computer program product of claim 16, wherein the calculating further comprises:
assigning, for each of the set of citizen sensor reports, a value to the citizen sensor report based on the one of positive feedback, neutral feedback, and negative feedback associated with the reporting target; and
calculating the impact factor of the context event as a sum of all the values assigned to the set of citizen sensor reports.

18. The computer program product of claim 17, wherein the assigning comprises:
calculating a contextualized weight value for the citizen sensor report based on the impact factor, wherein a lower contextualized weight value is calculated based on the impact factor being above a given threshold, and wherein a higher contextualized weight value is calculated based on the impact factor being below the given threshold.

19. The computer program product of claim 14, wherein the context event comprises at least one of time information, location information, weather information, health information, and queue waiting times.

20. The computer program product of claim 14, wherein the method further comprises:
classifying the reporting target of each of the plurality of citizen sensor reports based on the rank assigned to each of the citizen sensor reports.
